(19) United States
(12) Patent Application Publication
(10) Pub. No.: US 2006/0239426 A1
(43) Pub. Date: Oct. 26, 2006

(54) Grip surface handprint imaging scanner and method

(75) Inventors: John K. Schneider, Snyder, NY (US); Jack C. Kitchens, Tonawanda, NY (US); Stephen M. Gojevic, Lockport, NY (US)

Correspondence Address: HODGSON RUSS LLP, ONE M & T PLAZA, SUITE 2000, BUFFALO, NY, 14203-2391, US

(73) Assignee: Ultra-Scan Corporation

(21) Appl. No.: 11/347,757

(22) Filed: Feb. 3, 2006

Related U.S. Application Data
(60) Provisional application No. 60/650,409, filed on Feb. 4, 2005.

(51) Int. Cl. H04M 11/00

(52) U.S. Cl. 379/93.03

(57) ABSTRACT

A handprint scanner and related method are disclosed. The scanner may include a substantially cylindrical platen around which hands are placed for imaging. An ultrasound transducer array may be configured to spin just below the inner surface of the platen in order to collect information at discrete and precisely controlled points. The rotating transducer may be moved axially so that the result of collecting data in both the circumferential and axial directions results in a raster scan type image of the skin surface that is in contact with the platen.

### CROSS-REFERENCE TO RELATED APPLICATION

This application claims the benefit of priority to U.S. provisional patent application Ser. No. 60/650,409, filed on Feb. 4, 2005.

### FIELD OF THE INVENTION

The present invention relates to obtaining information which can be used to create an image representing the friction ridge surface of the skin of the hand, or portions of the hand such as the fingers, while gripping a substantially cylindrical measurement surface.

### BACKGROUND OF THE INVENTION

Since the 1800's handprint information, most notably fingerprint information, has been collected from human hands by means of ink and paper. For purposes of this document, the term “handprint” is used to mean the skin surface friction ridge detail of the entire hand or a portion of the hand, such as a single fingerprint. In recent years various electronic handprint scanning systems have been developed utilizing optical, capacitance, direct pressure, thermal and ultrasonic methods. Methods based on ultrasound have proven to be highly accurate, since they are insulated from the effects of grease, dirt, paint, ink and other image contaminants.

In an ultrasonic system, a piezoelectric transducer may be used to send an ultrasonic wave through an ultrasound transmitting media, such as mineral oil. In ultrasonic handprint scanners, the ultrasound wave is started and stopped to produce a pulse. At each material interface encountered by the pulse, a portion of the pulse reflects. For example, the interface between a platen and skin or the interface between air and skin may each reflect a portion of the pulse. The fraction of ultrasound reflected is a function of differences in impedance between the two materials comprising the interface. The fraction of ultrasound reflected can be calculated by the equation, R=((Z₁−Z₂)/(Z₁+Z₂))², where R is the fraction of sound reflected, Z, is the acoustic impedance of the first material and Z₂ is the acoustic impedance of the second material. Acoustic impedance is a measure of a material's resistance to the propagation of ultrasound. Acoustic impedance, Z, is defined as Z=r·c, where r is the material density, and c is the longitudinal propagation velocity of ultrasound in the material. The larger the change in acoustic impedance, the larger the fraction reflected.

The reflected wave pulses may be detected by the transducer. The elapsed time during which the pulse traveled from the transducer to the interface and back may be determined. The elapsed time may be used to determine the distances traveled by the pulse and its reflected wave pulses. By knowing the distance traveled, the position of an interface may be determined.

There may be many interfaces encountered by the emitted pulse, and so there may be many reflected wave pulses. Since it is the interfaces associated with a hand that are of interest in generating an image of a handprint, it may be necessary to identify those reflected wave pulses that are associated with the hand. The approximate position of a hand being scanned may be known, and therefore the pulse reflected from the hand may be expected during a particular time interval. In a technique commonly referred to as “range gating”, a detector may be configured to ignore reflected pulses that are not received during that time interval. Signals within the expected range may be interpreted to be reflected either from a ridge or a valley of the fingerprint. For example, those signals reflected from a ridge will be received before those signals reflected from a valley. The reflected signals associated with the finger may be processed and converted to a digital value representing the signal strength. The digital value may be used to produce a graphical display of the signal strength, for example by converting the digital values to a gray-scale bitmap image, thereby producing a contour map of the finger surface which is representative of the depth of the ridge structure detail.

Collecting information using an ultrasound transducer is usually accomplished by moving the ultrasound transducer side-to-side while advancing the transducer in a direction that is different from the side-to-side motion. Such an arrangement is commonly referred to as a raster scanning process. As the raster scanning process proceeds, the ultrasound raster scanning mechanism collects each pixel of image information individually, and records those pixels for use in generating an image of the fingerprint.

The prior art scanners are not able to scan more than a small portion of a hand. Since unique identifying features may be found in many areas of the hand, a scanner is needed which can provide information about larger areas of the hand.

### SUMMARY OF THE INVENTION

The invention may be embodied as a live-scan ultrasound skin grip surface handprint imaging scanner system for measuring and recording the skin surface ridge detail of the hand or hands for that portion of the skin surface that is in contact with a substantially cylindrical platen while the hand is grasping the platen. The scanning system may include a fixed substantially cylindrical platen around which hands are placed for imaging. An ultrasound transducer array may be configured to spin just below the inner surface of the platen. The transducers, which may be arranged in an array, collect information at discrete and precisely controlled points, and in this fashion collect information about the skin surface that is in contact with the platen. The rotating transducer array may be moved axially so that the result of collecting data in both the circumferential and axial directions results in a raster scan type image of the skin surface that is in contact with the platen. The area within the platen cylinder may be filled with an ultrasound transmission fluid, typically light mineral oil. An electronics subsystem may coordinate the axial and angular motion of the spinning transducer array and also collect data for the handprint image. A computer software subsystem suitable for displaying and extracting information from the image may be used for comparison of the extracted data to other skin surface data available in the identification system's biometric database.

A handprint scanner according to the invention may have (a) a curved platen having a first radius of curvature that is substantially constant in an area where information about a hand is to be gathered, (b) an energy transducer rotatably mounted so that the transducer moves along a path having a second radius of curvature, the second radius being less than the first radius, and (c) an angular motion system capable of moving the transducer along the path having the second radius of curvature. The energy transducer may be an ultrasound transducer. The platen may be a polymeric resin. A liquid transmission media may reside between the platen and the energy transducer. The angular motion system may include a cylinder to which the transducer is mounted. The invention may include an axial motion system capable of moving the transducer along a substantially straight line, and that axial motion may be substantially constant while information is gathered, or that axial motion may occur in a step-wise fashion. The line along which axial motion occurs may be substantially perpendicular to the second radius of curvature.

The invention may be embodied as a method, wherein (a) a curved platen may be provided, the platen having a first radius of curvature that is substantially constant in an area where information about a hand is to be gathered, (b) an energy transducer may be provided, the transducer being rotatably mounted so that the transducer moves along a path having a second radius of curvature, the second radius being less than the first radius, (c) a hand may be placed on the platen, (d) the transducer may be moved along the path having the second radius of curvature, (e) energy may be sent toward the hand, (f) some of the energy may be reflected from the hand to provide reflected energy, (g) the reflected energy may be received, and (h) the reflected energy may be used to produce an image of the hand. The transducer may be moved in a substantially linear direction, which may be substantially perpendicular to the path having the second radius of curvature. The transducer may be moved in the substantially linear direction while the transducer is moved along the path having the second radius of curvature. The transducer may be moved in the substantially linear direction in a step-wise fashion or in a substantially continuous fashion.

### BRIEF DESCRIPTION OF THE DRAWINGS

For a fuller understanding of the nature and objects of the invention, reference should be made to the accompanying drawings and the subsequent description. Briefly, the drawings are:

FIG. 1A, which depicts a scanner system in accordance with the invention, wherein part of the platen has been removed to reveal components inside the housing;

FIG. 1B, which is an end view of the scanner system depicted in FIG. 1A, with one of the end caps removed.

FIG. 2, which depicts the scanning motion of the cylinder and transducer during a scanning operation with a substantially continuous axial advance.

FIG. 3, which depicts the scanning motion of the cylinder and transducer during a scanning operation during which axial advances occur periodically to produce a step-wise axial advance of the transducer array.

FIG. 4A, which depicts another scanner system in accordance with the invention, wherein part of the platen has been removed to reveal components inside the housing.

FIG. 4B, which is an end view of the scanner system depicted in FIG. 4A, with one of the end caps removed.

FIG. 4C, which is a cross-sectional view of a shaft depicted in FIG. 4A and 4B.

FIG. 4D, which is an enlarged view of a portion of the scanner depicted in FIG. 4B, which shows devices for aligning the shaft.

FIG. 5, which depicts a method according to the invention.

### FURTHER DESCRIPTION OF THE INVENTION

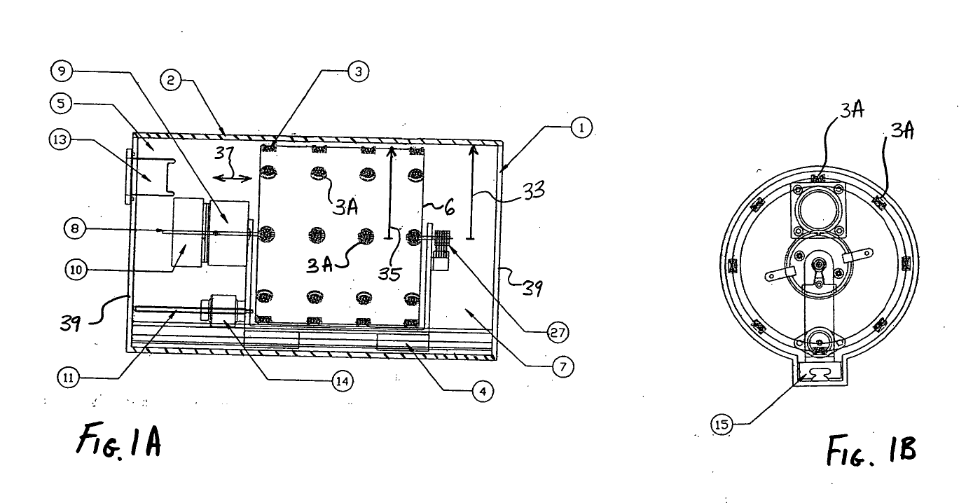

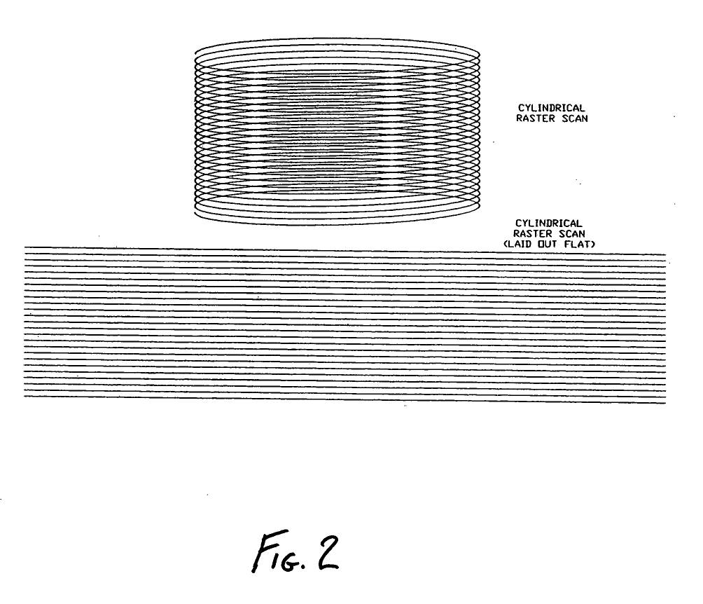

FIG. 1A and FIG. 1B depict an example of a live-scan ultrasound skin grip surface handprint imaging scanner system 1 that is in keeping with the invention. The scanner system 1 may be used to measure and record the skin surface ridge detail of the hand or hands for that portion of the skin surface that is in contact with a substantially cylindrical platen 2 while the hand is grasping the platen 2. The platen 2 may have a first radius of curvature 33. The platen 2 may be made from a polymeric resin, such as a polycarbonate resin, a cross linked polystyrene resin, acrylonitrile-butadiene-styrene (ABS) resin, or a polyacrylate (acrylic) resin.

14 The scanner system 1 may include a rotatable transducer array 3, which may include ultrasound transducers 3A capable of obtaining information about the friction ridge surface of a hand that is in contact with the platen 2. The transducer array 3 may be dynamically balanced so that it does not introduce wobble or other mechanical noise into the information produced by the transducers 3A.

An angular motion subsystem 8 may be used to move the transducer array 3 so that the transducer array 3 moves in a substantially circular manner, whereby the transducers 3A trace a substantially circular path having a second radius of curvature. A linear motion subsystem 4 may be used to move the angular motion subsystem 8 in a linear direction 37. A liquid non-conducting ultrasound transmission media 5 may be provided between the transducer array 3 and the platen 2.

The two motion control subsystems and transducer array 3 may be housed in a sealed chamber 7 formed by the platen 2 and two end caps 39. The problem of mismatch between the thermal expansion of the liquid transmission media 5 and the solid mechanical components may be solved by the use of a flexible bellows 13 or diaphragm that compensates for thermal mismatch.

The transducer array 3 may include a cylinder 6, to which the transducers 3A are attached. The angular motion subsystem 8 may include a synchronous motor 9 and rotary encoder 10, which may have a code wheel and calipers, that provide angular motion and precisely monitor the angular position of the transducer array 3.

The linear motion control system 4 may include a stepper type linear actuator motor 14, a worm drive 11 and a precision linear slide 15, to provide both linear motion and precise position monitoring. An alternate embodiment may be constructed with a synchronous motor and a linear position encoder.

Operation of the invention may be as follows. During a scanning operation, when the system scans for the presence of a hand on the platen 2, a microprocessor may synchronize and control the interaction of the scanning motion and processing of the signals from the ultrasound transducer array 3. Power may be applied to the angular motion subsystem 8 in order to spin the transducer array 3. The rotational position of the transducers 3A may be monitored by means of an optical encoder and code wheel. Each timing mark of the optical encoder may trigger a pulse-and-receive event on the spinning transducers 3A. An alternate embodiment of the system may use a single mark on the spinning transducer array 3 to accurately measure the period of revolution for the spinning array 3. From this information and the desired number of data points on the circumference of the cylindrical platen, an electronic timing mark may be generated to trigger pulse-and-receive events for the spinning transducers 3A. In this manner, information about the friction ridge surface along a circumferential line may be collected.

In one embodiment of the invention, the linear motion subsystem 4 and the angular motion subsystem 8 may move the transducer array 3 while the transducers are scanning. In this fashion, each transducer 3A may move in a spiral manner. FIG. 2 depicts the paths that might be traced by the transducers 3A when the linear motion subsystem 4 advances the transducers 3A in a substantially constant manner.

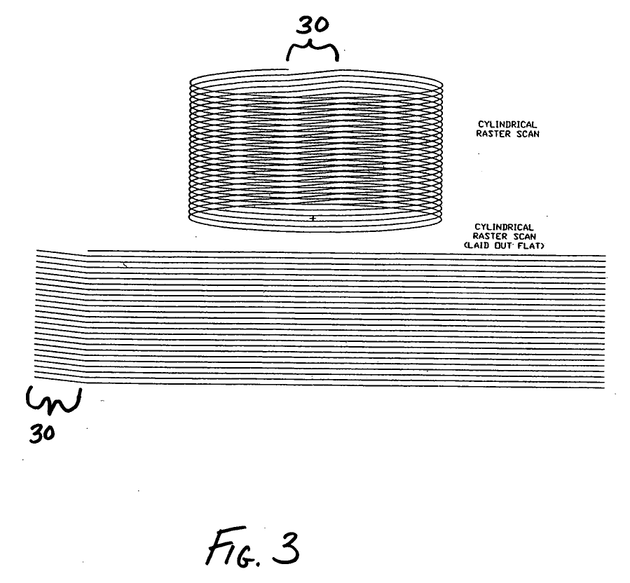

In another embodiment of the invention, the linear motion subsystem 4 may move the transducer array 3 in a step-wise fashion. Scanning may or may not occur while the linear motion subsystem 4 is axially advancing the transducer array 3. If scanning occurs while the linear motion subsystem 4 is axially advancing, a distortion band area 30 may be created, and this band area 30 may be kept as narrow as possible and in a region opposite the user so that it does not intersect or overlap the normal area used for the handprint image. FIG. 3 depicts the paths that might be traced by the transducers 3A when a stepper motor is used to axially advance the transducers 3A.

Power and input signals may be introduced to the spinning transducer array 3 through conductive brushes and rings, and output signals from the transducers 3A may be transmitted using similar devices. The transducers 3A may be in communication with signal conditioning electronics, which may include pulse generation circuits, timers, peak detectors and a digital control system. The control system may determine pulse timing, receive the transducer signals, convert the received signals to digital form and store the received signals in memory prior to transmission to an external electronics system. Output from the conditioning electronics may be broadcast through the transmission media 5 to an external receiver by radio frequency, infra-red, visible light or other non contact means. In an alternate embodiment, the signal conditioning system and most of the electronics may be external to the spinning transducer array 3. In this alternate embodiment, signals from the transducers 3A may be transmitted from the spinning transducer array 3 by means of conductive brushes and rings 27 in a manner similar to the commutator of a motor.

Using the information from the transducers, a handprint image may be created. The handprint image may be created using a computer and a software system that communicates digitally with the scanner system 1 to receive the information gathered by the transducers 3A.

During the construction and assembly of the scanner system 1, care must be taken to adjust the transducer array 3 and the platen 2 so that they are substantially concentric to each other, at least with regard to the area where information about a hand is to be gathered. Additionally, the individual transducers 3A may need to be individually adjusted radially so that they are focused on the surface of the platen 2 at the surface that contacts the user's hand. Focusing of the transducers 3A is important to the scanner system's 1 resolution and ability to measure ridge depth on the skin surface. Focusing the transducers 3A may be accomplished by means of a radial position adjustment mechanism associated with each transducer 3A, and the radial position may be adjusted during assembly of the scanner system 1. Radial position adjustment can be by means of a screw, friction fit or staking with an adhesive or potting compound or other means known to those versed in the art.

After the transducers 3A are properly positioned, the transducer array 3A may be calibrated. During calibration, each transducer's 3A focal position may be measured and its variation from ideal may be recorded. This information may be used during the image construction process as an offset or correction factor. Advanced image processing algorithms and post processing may be used to create a complete image that interlaces the signal image scan lines from each transducer 3A to create an error free image of the grip surface of the hand or hands that are in contact with the platen 2.

The rotation speed must be such that when a single transducer 3A sends an energy pulse (such as an ultrasound pulse) it is still in a position to receive the returning echo. In a system that uses mineral oil as the transmission media 5 and a polycarbonate platen 3, a suitable rotation speed may be determined by considering that mineral oil has a nominal speed of sound of 4661 ft/sec and polycarbonate has a nominal speed of sound transmission of 4545 ft/sec. For example, if the platen 2 thickness is ⅛ inch and the transducer maintains a distance of approximately 0.050 inches from the platen 2, then the time to send and receive a pulse echo back is 8.3 microseconds. If a transducer 3A, with a focused shaped emitter that is 0.40 inches in diameter and has a radius of curvature of approximately 0.375 inches, is used then even at a speed of revolution of 3600 rpm, the translation distance would only be 0.008 inches. The 0.40 inch diameter transducer 3A would be able to receive the return signal. However, if it is desired to maintain a resolution of 0.002 inches, then the speed would need to be limited to 900 rpm so that immediately upon receiving the return signal, a new pulse can be sent. If it is desired to maintain a resolution of 0.001 inches, then the speed would need to be limited to 450 rpm.

The platen 2 may be subjected to considerable force by a person that is having his friction ridge surfaces analyzed by the scanner system 1. To keep distortion of the platen 2 to a minimum and maintain accuracy of the system 1, it is believed that a polycarbonate platen 2 having a ⅛″ thickness may be suitable for the conditions that are expected where a law enforcement officer forcibly assists a subject who does not want his fingerprints taken. A thinner wall thickness would be allowable in a benign environment.

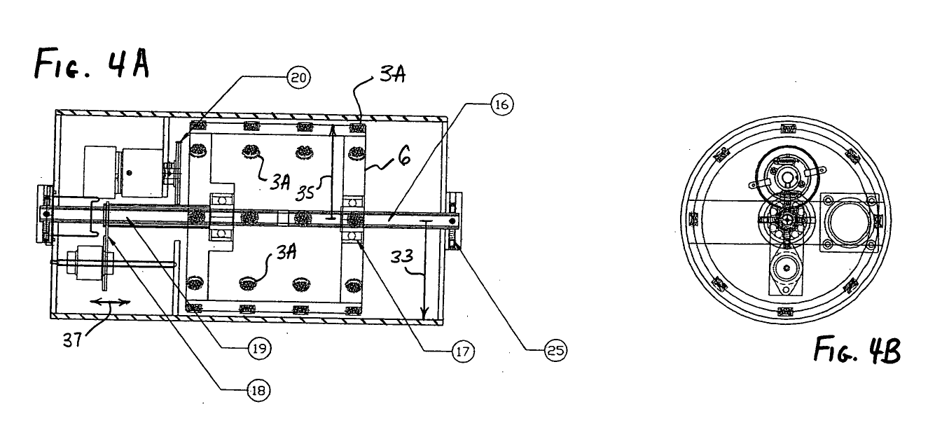

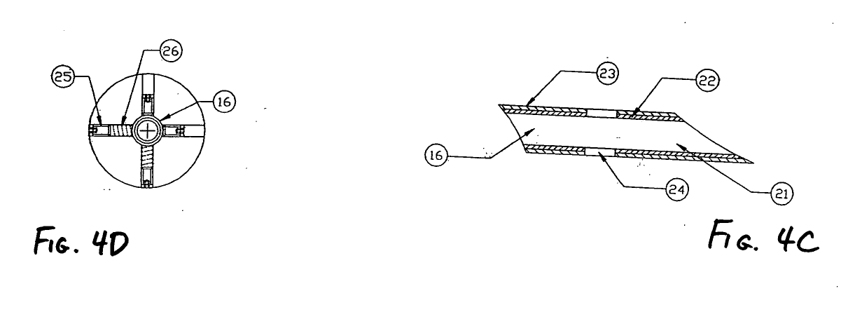

FIG. 4A and FIG. 4B depict an alternate embodiment of the invention, which eliminates the linear slide 15 and substitutes a shaft 16 that runs through and supports the entire rotating part of the system 1. A portion of the shaft 16 is shown in FIG. 4C. The bearings 17, which may be sized for a slight slip fit, may slip axially on the shaft 16 to allow sliding motion, and the transducers 3A may be driven by a gear 20 and pinion 19 system, which may be moved by a motor 9 /encoder 10 drive system. The linear motion subsystem 4 may engage the cylinder 6 via a fork type joint 18 and the worm drive 11 driven by the linear actuator motor 14, in order to provide axial movement of the transducers 3A. This configuration may be more difficult to manufacture, but offers the advantage of allowing the system 1 to scan a full 360° instead of having a dead band where the scan is blocked by the linear slide 15, worm drive 11, and linear actuator motor 14, as is the case for the embodiment depicted in FIGS. 1A and 1B. However, alignment of the cylinder 6 may be simplified, in that concentricity adjustment can be made at the housing attachment points with set screws 25 counterbalanced with a set of compression springs 26. See FIG. 4D. When the cylinder 6 is being aligned, the return signal of one or more of the transducers 3A may be monitored in order to determine whether the distance between the transducer 3A and the platen 2 is substantially the same (in the area where information will be gathered) while the cylinder 6 is rotated.

A complex center shaft 16 may be constructed with a solid metal core 21, insulated tubing 22, and metal tubing 23 separated by an insulating spacer 24. Such a shaft 16 may allow positive voltage to be supplied to one end of the shaft 16 and negative voltage to be supplied to the other end of the shaft 16. Electrical connection with the shaft 16 may be via bearings that contact the shaft 16.

An ultrasound scanning system 1 according to the invention may be used to create an image of the friction ridge skin surface of that portion of the hand that contacts the platen 2 while grasping the platen 2 as if to hold it. By utilizing a curved platen 2, in addition to obtaining the friction ridge surface of the hand and fingers in contact with the platen 2, the scanning system 1 may provide information related to the central area of the palm. This central palm area is normally unavailable for obtaining a friction ridge print if imaged by means of a flat imaging system. The curved platen 2 allows the slightly recessed portion of the palm to come in contact with the platen 2, and thereby allow image acquisition in this normally omitted area of the hand.

Since the platen 2 is substantially cylindrical and may be gripped by the hands in a natural manner, the scanner system 1 may allow for capturing the entire friction ridge skin surface that comes in contact with the platen 2. It is possible to capture simultaneously the images of both hands of a person being scanned. If the person being scanned is in a law enforcement situation where he/she is under restraint (handcuffs), the subject may be able to grasp the platen 2, and the transducer array will then acquire a skin surface image of both hands. This combined two hand image may be electronically processed. Further, individual fingerprint and palm print information may be separated from each other for use in populating a standard fingerprint card and fingerprint database.

By use of an array 3 of transducers 3A the process of data collection may be faster than if fewer transducers 3A are used. At a resolution of 500 dpi a single square inch of image surface has 250,000 pixels. The average time for a pulse to travel from the transducer 3A to the skin and return may be about 7 to 10 microseconds. Under these conditions, a one square inch area and a single transducer 3A will require 2.5 seconds to acquire an image. For a system that is 5 inches in diameter with an imaging width of 6 inches and 40 transducers 3A (5 rows of 8 transducers per row), a typical image acquisition time will be 6 seconds. This is a reasonable length of time for acquiring an image, even in those circumstances where a law enforcement officer must assist an uncooperative subject in keeping his hands in contact with the platen 2.

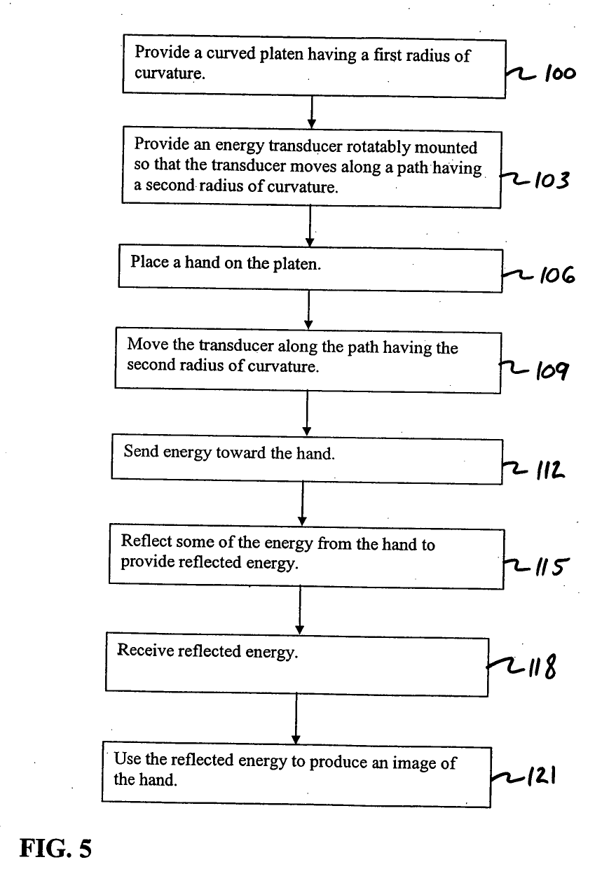

The invention may be embodied as a method. FIG. 5 depicts such a method in which a curved platen may be provided 100. The curved platen may have a first radius of curvature that is substantially constant in an area where information about a hand is to be gathered. An energy transducer may be provided 103 that is rotatably mounted so that the transducer moves along a path having a second radius of curvature. The second radius of curvature is less than the first radius of curvature so that the transducer may move in a substantially circular fashion within the platen. A hand may be placed 106 on the platen, and the transducer may be moved 109 along the path having the second radius of curvature. Energy may be sent 112 from the transducer toward the hand, and at least some of that energy may be reflected 115 from the hand to provide reflected energy. The reflected energy may be received 118, and used 121 to produce an image of the hand. For example, the reflected energy may be used 121 as input data to software designed to create an image of the friction ridge surface of the scanned hand.

As part of the method described above, the transducer may be moved in a substantially linear direction. The linear direction may be substantially perpendicular to the path having the second radius of curvature. Movement along the linear direction may be accomplished while the transducer moves 109 along the path having the second radius of curvature, and such linear movement may be done substantially continuously or in a periodic or step-wise fashion.

U.S. provisional patent application No. 60/650,409 discloses additional details about the invention and additional embodiments of the invention. The disclosure of that patent application is incorporated by this reference.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A handprint scanner, comprising:
a curved platen having a first radius of curvature that is substantially constant in an area where information about a hand is to be gathered;
an energy transducer rotatably mounted so that the transducer moves relative to the platen along a path having a second radius of curvature, the second radius being less than the first radius;
an angular motion system capable of moving the transducer along the path having the second radius of curvature.

2. The handprint scanner of claim 1, wherein the energy transducer is an ultrasound transducer.

3. The handprint scanner of claim 1, wherein the platen is a polymeric resin.

4. The handprint scanner of claim 1, further comprising a liquid transmission media residing between the platen and the energy transducer.

5. The handprint scanner of claim 1, wherein the angular motion system includes a cylinder to which the transducer is mounted.

6. The handprint scanner of claim 1, further comprising an axial motion system capable of moving the transducer along a substantially straight line.

7. The handprint scanner of claim 6, wherein the line is substantially perpendicular to the second radius of curvature.

8. A method of scanning a hand, comprising:
(a) providing a curved platen having a first radius of curvature that is substantially constant in an area where information about a hand is to be gathered;
(b) providing an energy transducer rotatably mounted so that the transducer moves relative to the platen along a path having a second radius of curvature, the second radius being less than the first radius;
(c) placing the hand on the platen;
(d) moving the transducer along the path having the second radius of curvature;
(e) sending energy toward the hand;
(f) reflecting at least some of the energy from the hand to provide reflected energy;
(g) receiving the reflected energy; and
(h) using the reflected energy to produce an image of the hand.

9. The method of claim 8, comprising moving the transducer in a substantially linear direction, the linear direction being substantially perpendicular to the path having the second radius of curvature.

10. The method of claim 9, wherein the transducer is moved in the substantially linear direction while the transducer is moved along the path having the second radius of curvature.

11. The method of claim 9, wherein the transducer is moved in the substantially linear direction in a step-wise fashion.
